(19) United States
(12) Patent Application Publication
(10) Pub. No.: US 2010/0078473 A1
(43) Pub. Date: Apr. 1, 2010

(54) PERIPHERAL INCLUDING BIOMETRIC READER AND CARD READER

(76) Inventor: Rafael Yepez, Sanford, FL (US)

Correspondence Address: PAUL W. MARTIN, NCR CORPORATION, LAW DEPT., 1700 S. PATTERSON BLVD., DAYTON, OH, 45479-0001, US

(21) Appl. No.: 12/243,597

(22) Filed: Oct. 1, 2008

(51) Int. Cl. G06K 7/08; G06K 9/00

(52) U.S. Cl. 235/380; 235/449; 382/124

(57) ABSTRACT

A peripheral including a biometric reader and a card reader which require less mounting space than separate devices. An example peripheral includes a magnetic stripe reader including a housing, and a fingerprint reader in the housing.

### BACKGROUND

Kiosks, automated teller machines, and other self-service computers may have limited space for peripherals.

It would be advantageous to provide a peripheral including a biometric reader and a card reader.

### SUMMARY

A peripheral including a biometric reader and a card reader is provided.

An example peripheral includes a magnetic stripe reader including a housing, and a fingerprint reader in the housing.

### DESCRIPTION OF THE DRAWINGS

FIG. 1 is a block diagram of an example travel kiosk.

FIG. 2 is a perspective view of the example travel kiosk.

FIG. 3 is a perspective view of the example travel kiosk illustrating a first technique for capturing a fingerprint.

FIG. 4 is a perspective view of the example travel kiosk illustrating a second technique for capturing a fingerprint.

FIG. 5 is a perspective view of the example travel kiosk illustrating a third technique for capturing a fingerprint.

FIG. 6 is a perspective view of the example travel kiosk illustrating a technique for reading a magnetic stripe on a card.

### DETAILED DESCRIPTION

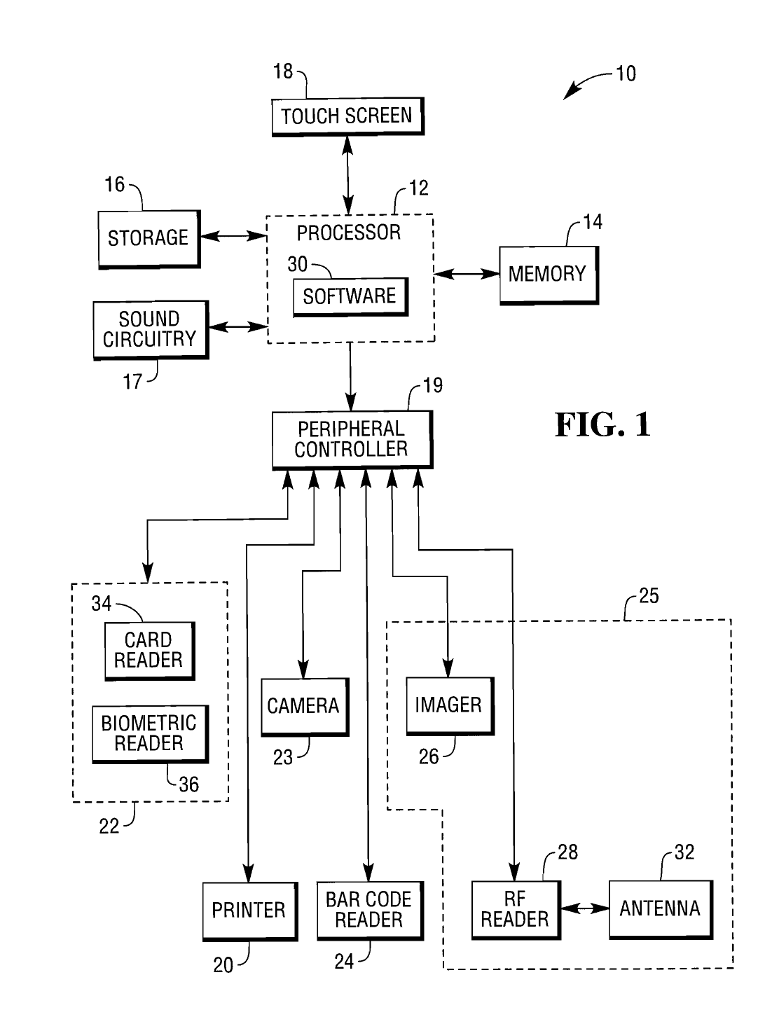

With reference to FIG. 1, an example self-service terminal 10 is illustrated. The example is a travel kiosk, though the peripheral of the present invention may be used in other types of self-service terminals, such as automated teller machines, self-service checkout stations, self-service entertainment rental kiosks, and other types of self-service kiosks. The peripheral of the present invention may also be used in other systems, for example, secure access systems for entering secured areas.

Travel kiosk 10 includes processor 12, memory 14, storage 16, and touch screen 18.

Processor 12 executes software 30 for displaying instructions, issuing prompts, and receiving inputs from users through touch screen 18. Processor 12 loads software 30 from storage 16 into memory 14 during execution.

Kiosk 10 may additionally include sound circuitry 17 for providing aural feedback to an operator during use of kiosk 10 and its peripherals. Sound circuitry 17 may include a tone generator and speakers.

Software 30 also controls a number of peripheral modules through one or more peripheral controllers 19. Peripheral controller 19 may include a serial controller, such as an RS232 or Universal Serial Bus (USB) controller.

Kiosk 10 includes a peripheral 22, which includes card reader 34 and biometric reader 36. Card reader 34 reads cards such as payment cards, loyalty cards, and driver's licenses under the control of software 30. Card reader 22 may include any of the known types of magnetic card readers, including a manual drag-through slot card reader, a motorized card reader, or an insertion type push-pull card reader.

Biometric reader 36 may include a fingerprint reader.

Software 30 may display a prompt asking a user to choose a method or device for identification. For example, software 30 may display choices including credit card, driver's license, or fingerprint. Software 30 records the choice via touch screen 18. Thereafter, software 30 may activate either card reader 34 or biometric reader 36 based upon the choice selected by the user. Software 30 may deactivate or ignore input from the reader that is not activated as a result of the selected choice.

Kiosk 10 may include other peripherals necessary for its purpose. For example, kiosk 10 may include printer 20, camera 23, barcode reader 24, and passport reader 25.

Printer 20 prints documents related to the purpose of self-service terminal 10, including receipts, tickets, boarding passes, and agendas under the control of software 30.

Barcode reader 24 reads barcode labels on documents related to the purpose of self-service terminal 10, such as receipts, coupons, driver's licenses, and travel documents under the control of software 30. Barcode reader 24 may also read barcodes displayed by portable devices, such as cell phones, personal digital assistants, and hand-held computers.

Passport reader 25 obtains information from passports. Passport reader 25 may include imager 26 and RF reader 28.

Imager 26 captures an image of a machine readable zone on passports under the control of software 30. Software 30 obtains information from the image via optical character recognition.

RF reader 28 interrogates and reads data from RF chips in passports through antenna 32 and under the control of software 30. RF reader 28 may also be used to read contactless payment cards.

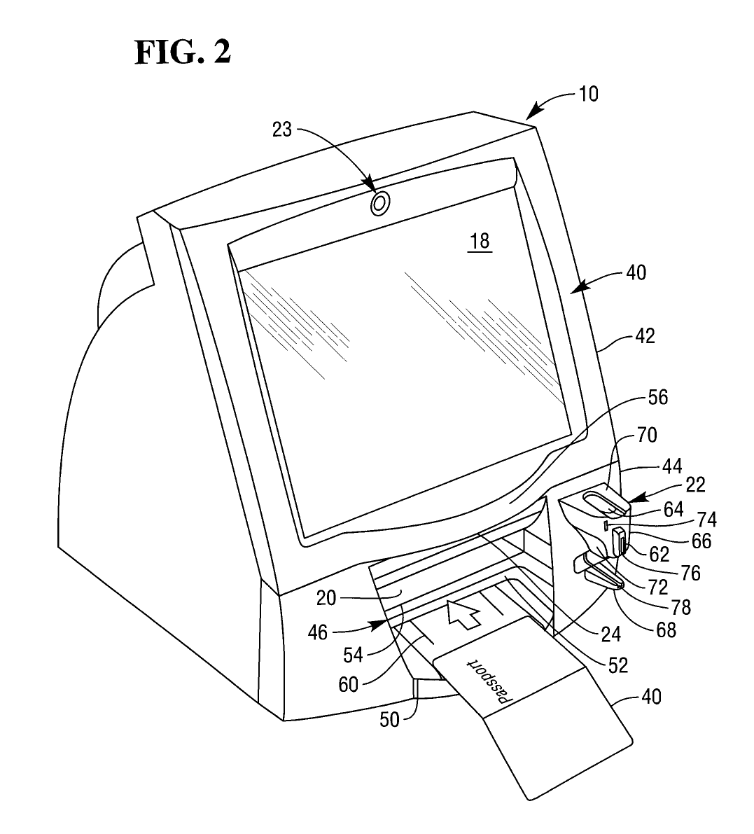

Turning now to FIG. 2, example travel kiosk 10 is illustrated in further detail.

Travel kiosk 10 includes a front surface 40 that provides a point of focus for user interaction. Front surface 40 includes top portion 42 and bottom portion 44.

Top portion 42 includes touch screen 18. Touch screen 18 provides a point of focus for users during display of instructions and receipt of touch entered data from users.

Bottom portion 44 includes peripheral 22, barcode reader 24, and passport reader 25.

Components in bottom portion 44 and organized into a work area 46 that provides a point of focus for users during printing of travel documents, reading of magnetic and contactless cards, reading of passports, scanning of barcodes on travel documents, and reading of biometric data.

Work area 46 includes shelf 50, passport tunnel 52, printer exit shoot 54, and overhang 56.

Shelf 50 includes guide edges 60 for aligning passport 40 with passport tunnel 52. Passport 40 is illustrated in a position aligned within guide edges 60.

Passport tunnel 52 retains passport 40 with travel kiosk 10 for capturing of information from machine readable zone by imager 26 and from an RF chip in passport 40 by RF reader 28.

Printer exit shoot 54 provides a location in work area 46 for depositing travel documents for user pickup.

Overhang 56 contains barcode reader 24 underneath. Barcode reader 24 is aimed in a generally downward direction in order to read barcode labels oriented upwards on travel documents placed in work area 46.

Adjacent work area 46 is an example peripheral 22, which includes an example magnetic stripe reader 62 and example fingerprint reader 64. Example magnetic stripe reader 62 includes an insertion type card reader. Because peripheral 22 combines magnetic stripe reader 62 and fingerprint reader 64, less area of surface 40 is required and a user's focus is directed to limited locations as with work area 46.

Example peripheral 22 includes housing portions 66 and 68, which extend from front surface 40. Housing portion 66 includes a substantially horizontal top surface 70, which contains an aperture exposing fingerprint reader 64. Housing portion 66 includes a bottom surface 71 which may be used for gripping during fingerprint reading. Housing 66 may further include recesses 70 on both sides, which may also be used for gripping housing 66 during fingerprint reading. Housing portion narrows from top surface 70 to upper track 76. The Housing 66 may further include a light 74 for indicating successful and/or unsuccessful reading of fingerprints.

Housing portion 68, together with housing portion 66, define upper and lower tracks 76 and 78 for constraining motion of a card when the card is inserted and removed for reading.

Example magnetic stripe reader 62 and fingerprint reader 64 may or may not share a common printed circuit board or control circuitry.

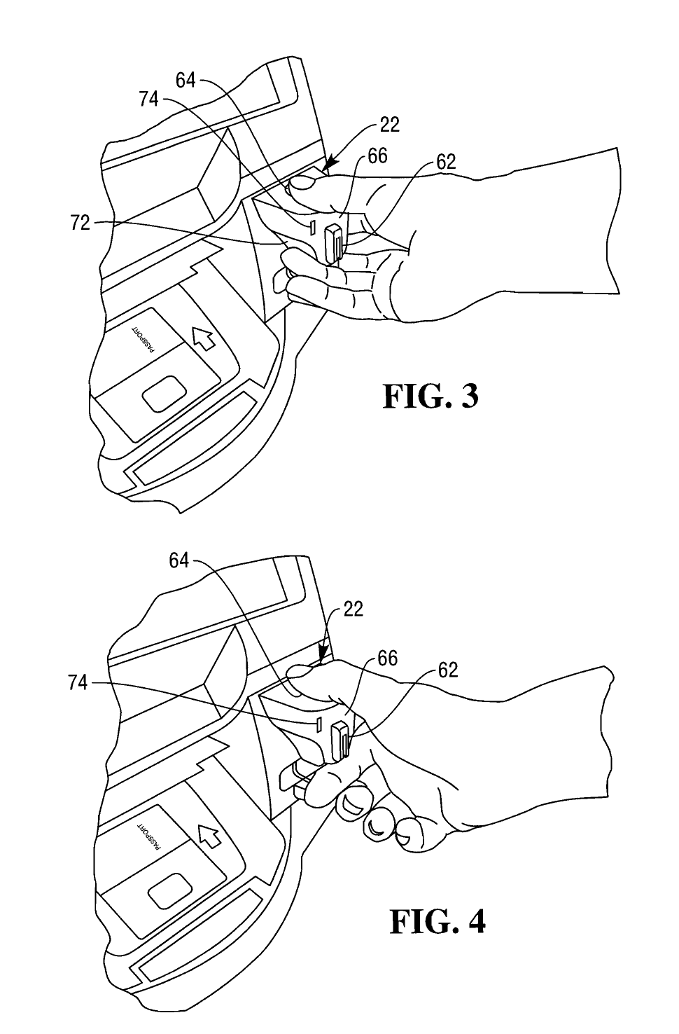

With reference to FIG. 3, a first technique of capturing a fingerprint using peripheral 22 is illustrated. In response to a prompt displayed by software 30, a user grasps housing portion 66 with fingers below and the thumb on top. Some of the fingers engage one or both of recesses 72. With the tip of the thumb on fingerprint sensor 64, peripheral 22 captures an image of the tip of the thumb under the control of software 30. Peripheral 22 provides an indication of a successful read via light 74 under the control of software 30.

With reference to FIG. 4, a second technique of capturing a fingerprint using peripheral 22 is illustrated. In response to a prompt displayed by software 30, a user partially grasps the leading portion of housing portion 66 with the index finger below and the thumb on top. With the tip of the thumb on fingerprint sensor 64, peripheral 22 captures an image of the tip of the thumb under the control of software 30. Peripheral 22 provides an indication of a successful read via light 74 under the control of software 30.

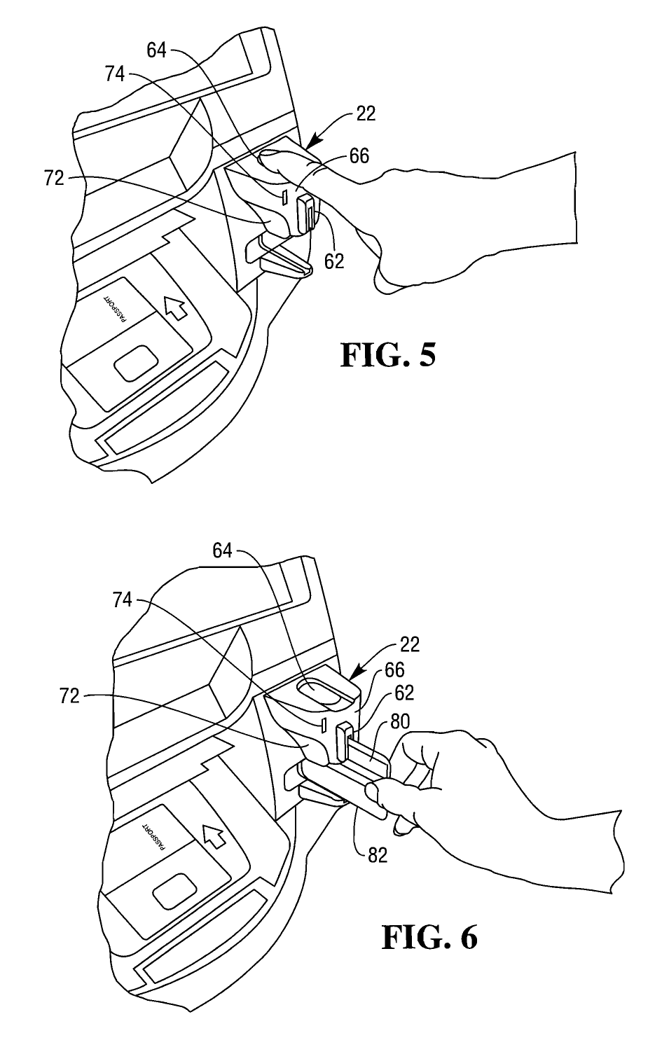

With reference to FIG. 5, a third technique of capturing a fingerprint using peripheral 22 is illustrated. In response to a prompt displayed by software 30, a user places the tip of the index finger on fingerprint sensor 64. Peripheral 22 captures an image of the tip of the index finger under the control of software 30. Peripheral 22 provides an indication of a successful read via light 74 under the control of software 30.

With reference to FIG. 6, a technique of reading a magnetic stripe 80 on a card 82, such as a driver's license using peripheral 22 is illustrated. In response to a prompt displayed by software 30, a user aligns card 82 with tracks 76 and 78, fully inserts card 82, and quickly removes card 82. Peripheral 22 reads the information on magnetic stripe 80 under the control of software 30.

Advantageously, the features of housing 66 provide a positive group for stabilizing the thumb for reading. Stabilizing the thumb improves read accuracy.

Although particular reference has been made to certain embodiments, variations and modifications are also envisioned within the spirit and scope of the following claims.

What is claimed is:

1. A peripheral comprising:
a magnetic stripe reader including a housing; and
a fingerprint reader in the housing.

2. The peripheral of claim 1, wherein the magnetic strip reader comprises an insertion type card reader.

3. The peripheral of claim 1, wherein the housing includes a substantially horizontal top surface including an aperture, and wherein the fingerprint reader is adjacent the aperture.

4. The peripheral of claim 1, wherein the housing includes recessed side surfaces for gripping during fingerprint reading.

5. The peripheral of claim 1, wherein the housing includes a bottom surface for gripping during fingerprint reading.

6. The peripheral of claim 1, wherein the housing includes first and second tracks for card reading.

7. A peripheral comprising:
an insertion type magnetic stripe reader including
a first housing portion with a substantially horizontal top surface including an aperture, a bottom surface, recessed side surfaces, and an upper track for card reading; and
a second housing portion with a lower track for card reading; and
a fingerprint reader adjacent the aperture;
wherein the bottom surface provides a first alternative gripping point during fingerprint reading and the recessed side surfaces provide a second alternative gripping point during fingerprint reading.

8. A kiosk comprising:
a peripheral including
a housing;
a card reader in the housing; and
a fingerprint reader in the housing;
wherein the housing includes points for gripping during fingerprint reading;
a display;
an input device; and
a processor for displaying a prompt directing an operator to choose a method of identification out of a plurality of methods of identification including identification by card and identification by fingerprint, for recording a choice via the input device, for processing identification information from the card reader when the choice is identification by card, and for processing identification information from the fingerprint reader when the choice is identification by fingerprint.

9. The kiosk of claim 8, wherein the magnetic strip reader comprises an insertion type card reader.

10. The kiosk of claim 8, wherein the housing includes a first portion with a substantially horizontal top surface including an aperture, and wherein the fingerprint reader is adjacent the aperture.

11. The kiosk of claim 8, wherein the points for gripping include recessed side surfaces.

12. The kiosk of claim 8, wherein the points for gripping include a bottom surface.
